(19) United States
(12) Patent Application Publication
(10) Pub. No.: US 2026/0354938 A1
(43) Pub. Date: Nov. 12, 2026

(54) TECHNIQUES FOR SECURING THERMOFORM MOLDS

(71) Applicant: Institut Straumann AG, Basel (CH)

(72) Inventors: Benjamin Butler, Cedar Park, TX (US); Miguel Guerrero, Austin, TX (US)

(73) Assignee: Institut Straumann AG, Basel (CH)

(21) Appl. No.: 19/134,489

(22) PCT Filed: Nov. 30, 2023
(86) PCT No.: PCT/IB2023/062084

§ 371 Date: May 30, 2025

Related U.S. Application Data
(60) Provisional application No. 63/428,923, filed on Nov. 30, 2022.

(51) Int. Cl. A61C 7/08; A61C 7/00; B29C 51/26; B29C 51/36; B29L 31/00

(52) U.S. Cl. CPC A61C 7/08; A61C 7/002; B29C 51/264; B29C 51/36; B29L 2031/7536

(57) ABSTRACT

The present disclosure discusses techniques for securing thermoform models, including a locator plate for receiving and securing individually unique dental models having a raised polygon cutout together with a locator pin, a system for thermoforming an orthodontic aligner, and methods thereof.

### CROSS-REFERENCE TO RELATED APPLICATIONS

This application claims priority to and the benefit of U.S. Provisional Patent Application Ser. No. 63/428,923, entitled “Techniques for Securing Thermoform Models” filed on Nov. 30, 2022. The entire content of the U.S. Provisional Patent Application Ser. No. 63/428,923 is incorporated herein by reference.

### FIELD OF THE TECHNOLOGY

The present technology relates to dental appliance manufacturing techniques. More specifically, this technology relates to techniques for securing thermoform models.

### BACKGROUND

Orthodontic aligners are appliances intended to make a series of discrete tooth position corrections aimed at aligning the teeth correctly. Aligners are equivalent to having bracket/wire braces for orthodontic treatment but they have many advantages. For example, aligners are often transparent or semi-transparent, comfortable and removable for cleaning and they allow a patient to eat anything they want. The manufacture of aligners traditionally begins with generating a digital model of the patient's teeth, either by scanning the patient's teeth, or by making a dental impression of the patient's teeth and then scanning the impression. Once a digital model of the patient's teeth has been acquired, physical dental models can be fabricated (e.g., using 3D printing techniques) to provide a positive model of the teeth, also known as the dental arch.

When an intra-oral scanning device (IOS device) is used to scan a patient's teeth, three dimensional computer aided design (CAD) representations to be imported by custom software. The custom software allows the operator to move individual teeth in specific and discrete movements to achieve the final dental arch of aligned teeth.

A 3D printed arch model is washed and then allowed to dry. Once dried, a polymer is thermoformed over the top of the 3D printed arch model.

The thermoformed part is then laser marked with part identification. The laser marked, thermoformed part is then cut by one of several methods so that the aligner that goes to the customer can be separated from the excess aligner material.

The aligner is then polished in a part tumbling process to remove burrs and sharp edges. The aligners are inspected and then sealed in bags to be shipped to the customer's orthodontist, or directly to the patient.

Previous thermoforming designs had problems with securely locating a 3D printed arch model for pressure forming a heated plastic film with minimal added material. In addition to having excess material, these designs did not always hold the model accurately.

### SUMMARY

The present technology solves the above problems by using a locator plate having a raised polygon feature and a locator pin. In some embodiments, the polygon feature is a pentagon that has a rectangular bottom portion and an isosceles triangle top portion. The pentagon and locator pin significantly improve hold accuracy with minimal extra material needed and works with 99.9% of arch shapes. The present technology also allows for additional manufacturing information to be easily visible as needed. The present technology is significantly more flexible while using less material than competing designs. The present technology also advantageously shows manufacturing information in a more obvious/helpful way.

It was surprisingly discovered that the shape of the raised pentagon is compact enough to fit internal to all human dental arches, robust enough to not be damaged or broken during processing, easy to manufacture, quickly shows product orientation, easy to mate to, and has enough surface area to keep the parts from rotating. In particular, the pointed end of the pentagon is easy to orient to; the shape allows for a front-to-back loading action that is ergonomic and self-aligning; and the flat sides of the shape prevents 3D arch rotation.

In an embodiment, the technology is directed to a locator plate for receiving and securing individually unique dental models.

In some embodiments, the locator plate has a raised pentagon extending from a surface of the locator plate and having a rectangular bottom portion and an isosceles triangle top portion and a locator pin.

In some embodiments, the raised pentagon is located in the center of the locator plate.

In some embodiments, the locator pin is spaced from the raised pentagon, the locator pin extending from the surface of the locator plate.

In some embodiments, the locator plate further has a first locator cone, a second locator cone, and a third locator cone spaced away from the raised pentagon and the locator pin in a triangular arrangement.

In some embodiments, at least one of the raised pentagon and locator pin is chamfered.

In some embodiments, the locator pate has raised lettering spaced away from the raised pentagon.

In some embodiments, the locator plate further has a dental model affixed to the raised pentagon and the locator pin for forming a dental aligner.

In some embodiments, the locator plate further has a polymer sheet drawn over the dental model for the formation of a dental aligner.

In an embodiment, the technology is directed to a method of thermoforming a dental aligner, the method having the steps of printing a 3D dental model including a positive model of a dental arch, and a 3D printed locator tab positioned within an interior of the dental arch; providing a locator plate having a raised polygon and a locator pin extending from a surface of the locator plate; securing the 3D dental model to the locator plate by positioning the raised polygon within the polygon cutout, and positioning the locator pin within the pin cutout; and thermoforming a polymer sheet over the dental model secured to the locator plate.

In some embodiments, the printing step includes printing edges of a polygon cutout within the 3D printed locator tab and printing a boundary of a pin cutout within the 3D printed locator tab.

In some embodiments, the method further includes moving the 3D dental model into a proper position for thermoforming by repositioning the locator plate.

In some embodiments, the raised polygon of the locator plate has an apex oriented toward an incisal portion of the dental arch indicating a proper orientation of the 3D dental model with respect to the raised polygon of the locator plate.

In some embodiments, the raised polygon of the locator plate and the polygon cutout within the 3D printed locator tab are pentagonal.

In some embodiments, the printing of the 3D dental model step further includes 3D printing edges of cutout lettering positioned along one or more edges of the polygon cutout.

In some embodiments, the printing of the 3D dental model step further includes 3D printing raised lettering positioned along one or more edges of the polygon cutout.

In some embodiments, the locator plate further defines three concave locator cones formed within the surface of the locator plate from which the raised polygon and locator pin extend.

In some embodiments, the concave locator cones are positioned in a triangular arrangement with respect to the raised polygon.

In some embodiments, thermoforming the polymer sheet further includes thermoforming a portion of the polymer sheet within the concave locator cones.

In some embodiments, the triangular arrangement of the concave locator cones, when transferred to the thermoformed polymer sheet, indicates an orientation of the thermoformed polymer sheet.

In an embodiment, the technology is directed to a system for thermoforming an orthodontic aligner having a locator plate having a raised polygon and a locator pin extending from a surface of the locator plate; a 3D dental model including a positive model of a dental arch, a 3D printed locator tab positioned within an interior of the dental arch; and a heat source for thermoforming a polymer sheet over the 3D dental model once secured to the locator plate.

In some embodiments, the system includes printing the 3D dental model defines edges of a polygon cutout within the 3D printed locator tab and a boundary of a pin cutout within the 3D printed locator tab.

In some embodiments, the 3D dental model mates with the locator plate by positioning the raised polygon within the polygon cutout, and positioning the locator pin within the pin cutout.

In some embodiments, the 3D printed locator tab includes cutout lettering or raised lettering positioned along one or more edges of the polygon cutout.

In some embodiments, the system further includes a camera for viewing and identifying the cutout lettering or raised lettering positioned along one or more edges of the polygon cutout.

In some embodiments, the locator plate further defines three concave locator cones formed within the surface of the locator plate from which the raised polygon and locator pin extend, the concave locator cones being positioned in a triangular arrangement with respect to the raised polygon.

In some embodiments, the triangular arrangement of the concave locator cones, when transferred to the thermoformed polymer sheet, indicates an orientation of the thermoformed polymer sheet.

### BRIEF DESCRIPTION OF THE DRAWINGS

The technology will be more fully understood from the following detailed description taken in conjunction with the accompanying drawings, in which:

FIG. 1 shows a top view picture of aligner material thermoformed on the 3D arch model.

FIG. 2 shows a side view picture of aligner material thermoformed on the 3D arch model.

FIG. 3 shows a reversed top view picture of aligner material thermoformed on the 3D arch model.

FIG. 4 shows a top view diagram of a raised pentagon and locator pin of the locator plate.

FIG. 5 shows a top view diagram of a raised pentagon, locator pin, and lettering of the locator plate.

FIG. 6 shows a top view diagram of a raised pentagon, locator pin, three locator cones, and four holes of the locator plate.

FIG. 7 shows a 3D top and side view diagram of a raised pentagon, locator pin, three locator cones, and four holes of the locator plate.

FIG. 8 shows a top view diagram of a raised pentagon and cylindrical locator pin of the locator plate.

FIG. 9 shows a bottom view diagram view of the locator plate.

FIG. 10 shows a 3D bottom and side view diagram view of the locator plate.

FIG. 11 shows a flow chart of an exemplary method embodiment of the thermoforming technology.

### DETAILED DESCRIPTION

The present technology includes a locating plate for receiving and securing individually unique dental models having a raised polygon cutout together with a locator pin for improved securing thermoforming models. The technology further includes a system for thermoforming an orthodontic aligner and a method for of thermoforming a dental aligner.

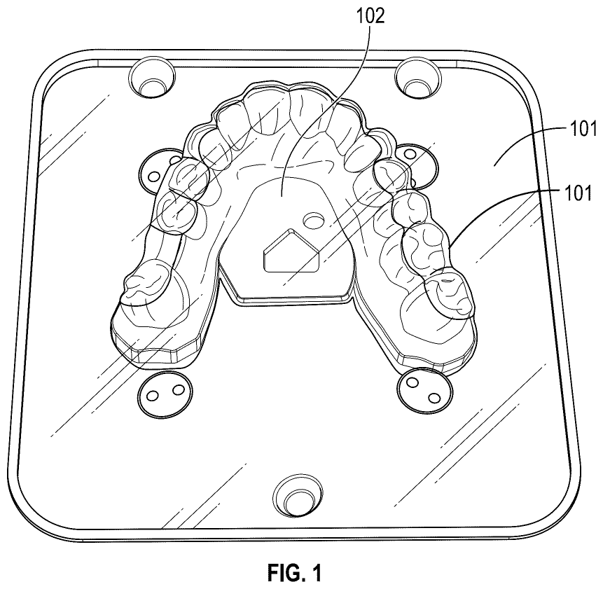

In an example, the technology is directed to a locator plate for receiving and securing individually unique dental models such as shown in FIGS. 1-10.

In some examples, the locator plate has a raised polygon, such as a pentagon, extending from a surface of the locator plate and having a rectangular bottom portion and an isosceles triangle top portion and a locator pin as shown in FIGS. 1-8. In some examples, the raised pentagon is located in the center of the locator plate. In some examples, the locator pin is spaced from the raised pentagon, the locator pin extending from the surface of the locator plate.

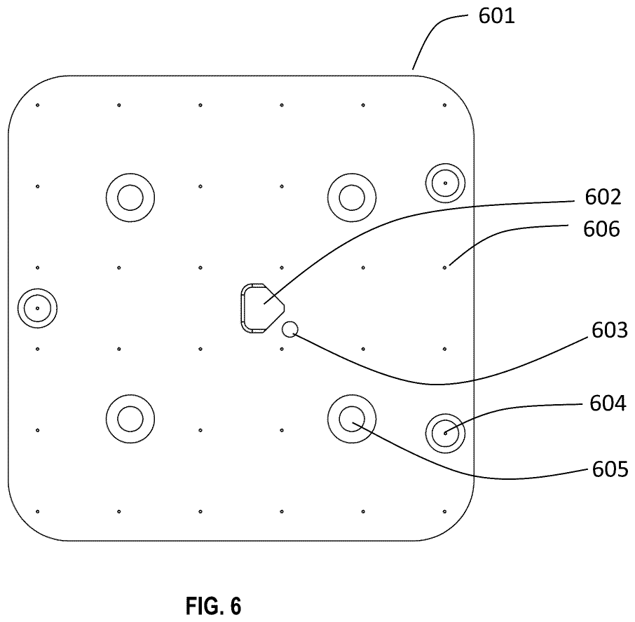

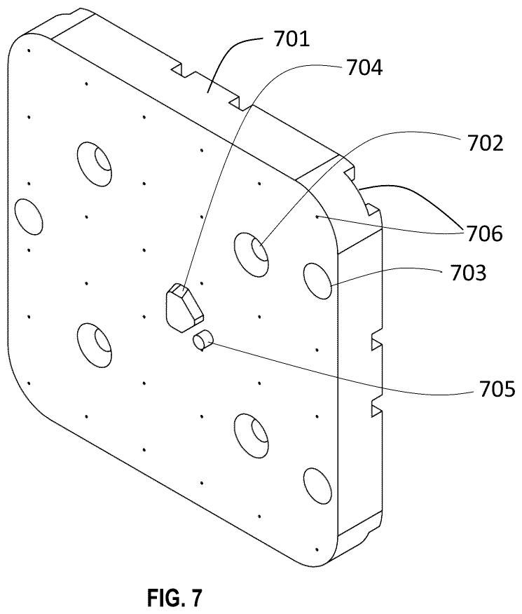

In some examples, the locator plate further has a first locator cone, a second locator cone, and a third locator cone spaced away from the raised pentagon and the locator pin in a triangular arrangement as shown in FIGS. 6 and 7.

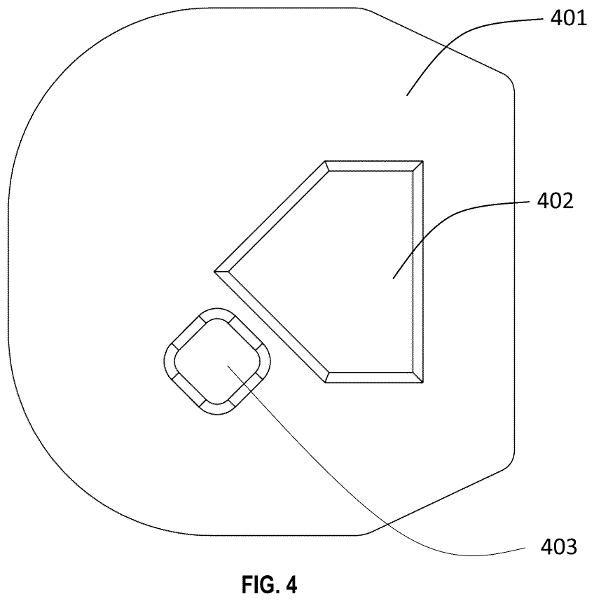

In some examples, at least one of the raised pentagon and locator pin is chamfered as shown in FIGS. 4-8. The chamfered edges of the raised pentagon and locator pin can help the dental model more easily fit into place.

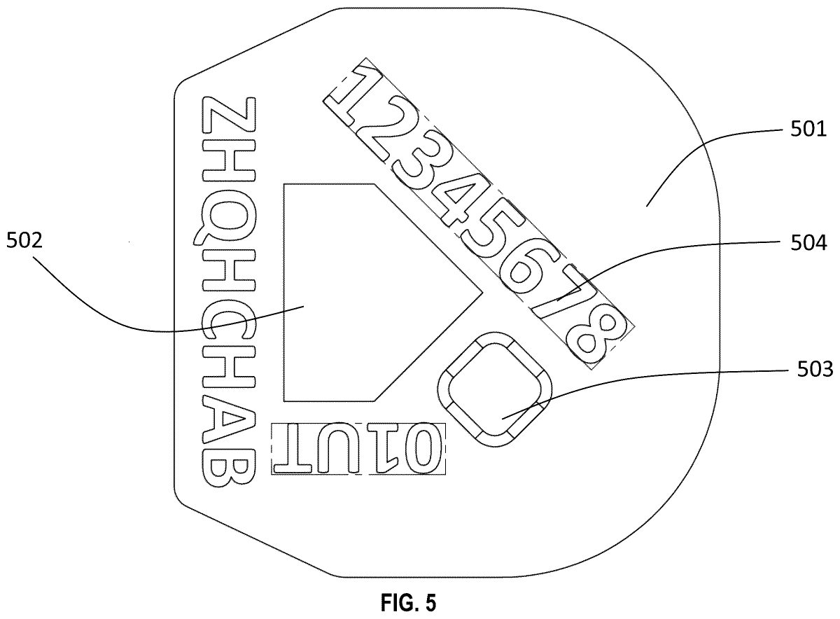

In some examples, the locator pate has raised lettering spaced away from the raised pentagon as shown in FIG. 5. The raised lettering can include a product identifier, a case identifier, a batch identifier, or another type of code that is used in downstream processing and manufacturing steps during the aligner production process.

In some examples, the locator plate further has a dental model affixed to the raised pentagon and the locator pin for forming a dental aligner. In some examples, the locator plate further has a polymer sheet drawn over the dental model as shown in FIGS. 1-3.

Specifically, FIG. 1 shows a polymeric material 101 thermoformed on a dental model 102 that was attached to a locator plate (not shown) in accordance with the present technology.

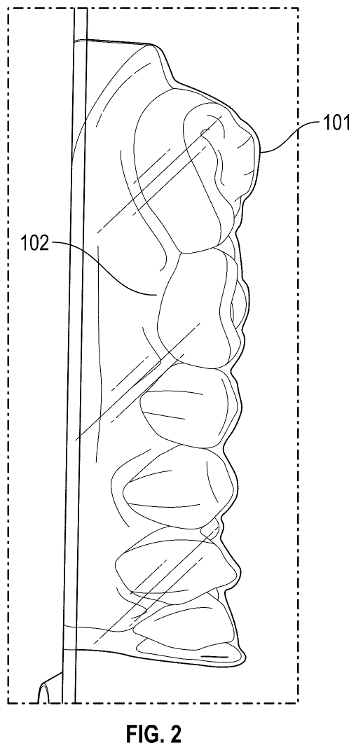

FIG. 2 provides a side view of the polymeric material 101 after it is thermoformed on the dental model 102.

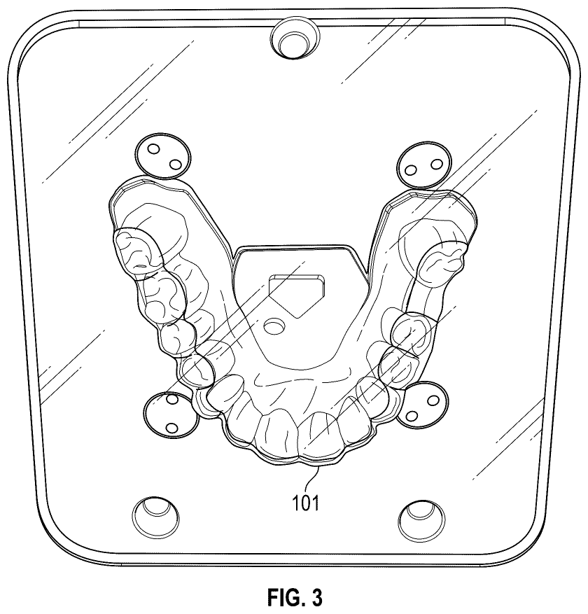

FIG. 3 provides another top view of the polymeric material 101 thermoformed on the dental model 102.

In each of FIGS. 1-3, the drawings show the aligner still attached to the thermoformed product. That is, while the locator plate has been removed, the dental model 102 is still connected to the thermoformed sheet. In addition, the thermoformed polymeric material still needs to be cut out from the sheet 101 and the dental model removed, before finishing work can occur (e.g., trimming, deburring, polishing, etc.) before the final appliance (i.e., the aligner) is ready for the specific patient's use (i.e., patient corresponding to the attached model).

As also evident from FIGS. 1-3, the polymeric material is a thin thermoformable material. The thickness of the polymeric material is not particularly limited but should be of sufficient thickness to thermoform around a dental model. Preferably, the polymeric material is less than 5 mm thick. More preferably, the thickness of the polymeric material may be from about 0.05 to about 5 mm thick.

Examples of thermoforming materials include but are not limited to polyethylene terephthalate (PET), polyethylene terephthalate glycol (PETG), thermoplastic polyurethane (TPU), polyvinyl chloride (PVC), and other biocompatible polymers with suitable elasticity and plasticity for thermoforming.

The polymeric material 101 can include, for example, a multilayer polymeric material such as those described in U.S. Pat. No. 10,549,511; U.S. Pat. No. 10,870,263; U.S. Pat. No. 10,987,907; U.S. Pat. No. 11,325,358; U.S. Pat. No. 10,946,630; US Patent Publication No. 2022/0118747; PCT Application No. PCT/US2020/065928; PCT Application No. PCT/US2022/025306; and Provisional U.S. Patent Application No. 63/354,998; all of which are incorporated by reference in their entirety.

When the thermoforming material is exposed to heat, the material becomes more pliable, which allows the material to mold and take the shape of an imprint when adequate pressure is applied.

However, consistently and firmly securing the 3D model during thermoforming can be challenging. The present technology solves this issue by developing a unique locator plate having locator features that are designed to assist in securely locating and mating with the dental model for optimal thermoforming.

FIG. 4 shows a top-down perspective of a locator tab 401 having a cutout pentagon shape 402 formed within a portion of the 3D printed dental model. As discussed above and shown in FIGS. 1 and 3, the locator tab can be positioned within the interior of the dental arch and can be formed during the 3D printing process. The locator tab 401 in this embodiment includes a pentagon cutout 402 shaped to be placed around a raised pentagon, as well as a pin cutout 403 shaped to be placed around a locator pin. After experimenting with various shapes, the pentagon shape having a rectangular bottom portion and an isosceles triangle top portion demonstrated optimal fit and alignment accuracy when mating a dental model with a locator plate. FIG. 4 also shows a pin cutout 403, which assists in locating and positioning the dental model to ensure superior alignment. In FIG. 4, both the pin cutout 403 and the pentagon cutout 402 are chamfered. The chamfer makes it easier for the locator plate to mate to the dental model and reduces the likelihood of flashing or extra material from the 3D printing process affecting proper mating. In an embodiment, the locating plate has a chamfer on the back and sides of the pentagon shape, which also helps for alignment.

FIG. 5 shows another top-down perspective of a locator tab 501 having a having a polygon cutout 502 in the form of a pentagon shape having a rectangular bottom portion and an isosceles triangle top portion, and a pin 503 cutout for assisting in locating and positioning the dental model. FIG. 5 also shows alphanumerical lettering 504 that may be presented in various locations on the locator tab 501. This lettering is preferably in the form of raised lettering and spaced away from the pentagon cutout 502. In FIG. 5, the alphanumerical lettering 504 is presented at three different locations on the locator tab 501 around the pentagon cutout 502. The alphanumerical lettering is used to identify and match to a specific 3D model. For example, a computer having a detector (e.g., using an optical character recognition camera) can scan the locator tab, read the lettering, and match a dental model based on the lettering instructions, which further streamlines the thermoform process.

In an example, the alphanumerical lettering represents a case number and/or a step/arch identifier, which may be in the form of an encrypted hexadecimal code. In some embodiments, rather than being raised lettering, the lettering may be cut through the entire model to allow for more accurate reading from an optical character recognition camera. In a preferred embodiment, the length of the raised text is at least 1 mm, which overcomes potential issues in 3D printing. In an alternative embodiment, the lettering is entirely cut through the thickness of the locating plate. Having cutout lettering can further reduce the amount of material required during the 3D printing process.

The distances between an arch and the locator tab may be varied as each arch has a unique anatomical shape. Thermoforming digital software in combination with the lettering are used to determine a distance for each arch. Based on a known location of the arch, the software ensures the lettering is showing when it merges one or more locating features with the arch.

FIGS. 6-10 show various exemplary locator plate designs having locator features that are used for locating and securing to the dental model.

FIG. 6 shows a top-down perspective of a locator plate, which includes a raised chamfered pentagon shape 602 extending from a surface of the locator plate 601 and having a rectangular bottom portion and an isosceles triangle top portion, the raised pentagon located in the center of the locator plate. Adjacent to the pentagon shape is a cylindrical locator pin 603 spaced from the raised pentagon, the locator pin extending from the surface of the locator plate. Locator cones 604 are spaced away from the raised pentagon and the locator pin in a triangular arrangement and mounting holes 605 spaced from the raised pentagon and the locator pin in a square arrangement for mounting the locator plate on a thermoforming system. In some embodiments, the mounting holes 605 can be used to securely mount the locator plate 601 to various components in an assembly line manufacturing process. The locator cones 604 are another locator feature that assist in locator plate arrangement relative to the dental model. The locator plate also has smaller holes 606, which allow for air to escape during the thermoforming process that may get trapped between the thermoforming material and the locator plate and allow for a more secure fit. In some embodiments, a vacuum system can be incorporated into the thermoforming system that can provide suction through the smaller holes 606 to assist with holding the polymeric material securely to the locator plate 601. While FIG. 6 only shows some sides of the raised pentagon shape 602 to be chamfered, more or fewer edges of the raised pentagon shape 602 can be chamfered in order to assist with positioning the dental model on the locator plate 601. The locator pin 603 can also have a chamfered upper surface, in some embodiments.

FIG. 7 shows a three-dimensional perspective of a locator plate as shown in FIG. 7, which includes a raised chamfered pentagon shape 704 extending from a surface of the locator plate 701 and having a rectangular bottom portion and an isosceles triangle top portion, the raised pentagon located in the center of the locator plate; a cylindrical locator pin 705 spaced from the raised pentagon, the locator pin extending from the surface of the locator plate; locator cones 703 spaced away from the raised pentagon and the locator pin in a triangular arrangement; and mounting holes 702 spaced from the raised pentagon and the locator pin in a square arrangement. In some embodiments, the mounting holes 702 can be used to securely mount the locator plate 701 to various components in an assembly line manufacturing process. Smaller holes and grooves 706 allow for air to escape during the thermoforming process that may get trapped between the thermoforming material. In some embodiments, a vacuum system can provide suction through the smaller holes 706 to assist with holding the polymeric material securely to the locator plate 701.

Preferably, the locator cones 703 can be cone-shaped indentations within the locator plate 701 and are arranged as three cones that are spaced in a triangular formation as shown in FIGS. 6 and 7. During the thermoform process, a portion of the polymeric material can be thermoformed into the locator cones 703, resulting in three thermoformed features in the polymeric material (examples of these features can be seen in FIGS. 1 and 3). In some embodiments, these thermoformed cone features can assist with orienting the aligner material and dental model during downstream processes, such as laser marking.

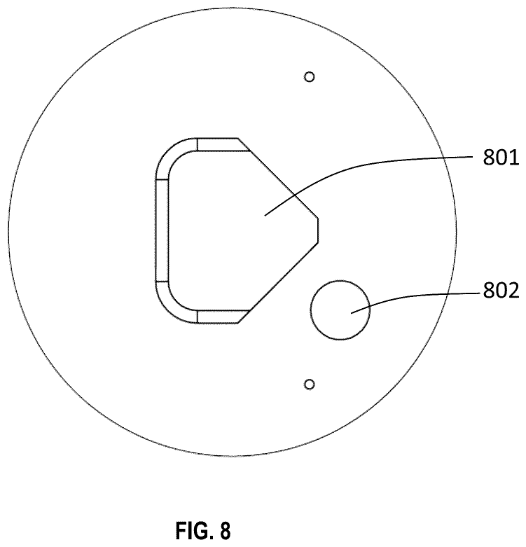

FIG. 8 shows a top-down perspective focusing on the raised polygon shape 801 and locator pin 802. The polygon shape 802 is preferably compact enough to fit internal to all human dental arches and chamfered for a better fit and avoiding dental model mating issues caused from defects in 3D printing. The polygon cutout is preferably robust enough to not be damaged or broken during processing. Additional advantages of the polygonal shape include that the shape is easy to manufacture, quickly shows product orientation, easy to mate to, and has enough surface area to keep parts from rotating.

In a preferred example, the polygon is a pentagon shape, which is useful in that it is optimal for the above criteria. In a more preferred example, the pentagon shape has a substantially rectangular and slightly rounded bottom portion and an isosceles triangle top portion, with the raised pentagon located in the center of the locator plate. The point on one end is easy to orient to, which allows for a front-to-back loading action which is ergonomic and self-aligning and the flat sides of the rectangular portion of the pentagon help avoid the part from rotating. In some embodiments, the point on the raised pentagon 801 may be trimmed or cut off, as shown in FIG. 8, in order to further assist with mating the dental model with the locator plate.

The number of locator features is not limited. In an alternative example, the locating plate has more than one polygon cutout. In another example, additional locator cutouts such as additional locator pins may be used and may be optimized based on the specific design of the thermoforming system employed.

In an example, digital software is used to determine distance for each arch. The software may assist in tracking where the arch is and ensuring all text is showing when it merges the locating feature with the arch.

The lettering may include a case number and step/arch identifier above the edges of the polygon cutout. In one example, the lettering is an encrypted hexadecimal code. The lettering may be at the bottom of the polygon (e.g., pentagon) and may be cut through the entire model to allow for more accurate reading from an optical character recognition camera.

Any suitable length of raised lettering from the locator tab may be used. In a preferred example, the raised text may be at least 1 mm. In a preferred example, the cut through text is entirely cut through the thickness of the locating plate.

The raised polygon, locator pin, and/or locating plate may be chamfered. Chamfering advantageously allows for easier mating. Chamfering also advantageously helps reduce the likelihood of any flashing or extra material from the 3D printing process preventing parts in the thermoforming process from mating properly. In a preferred example, the locating plate has a chamfer on the back and sides of the pentagon to help for alignment.

The locating plate may include one or more grooves and/or holes to allow for air to escape during the thermoforming process that may get trapped between the film and the plate. These holes may also be used with a vacuum system to help securely hold the polymeric material to the locator plate.

In a preferred example, the locator pin is spaced from the raised polygon. Having the pin spaced from the polygon advantageously improves the locating feature(s) to keep the arch oriented in the correct location. Spacing the locator feature(s) apart advantageously minimizes potential variations in 3D arch dimensions from affecting the thermoforming process. 3D printed parts often result in some degree in variation in dimensions from part to part based on the printer accuracy. How well the 3D arch model is located will also affect the accuracy for laser marking and robotic trimming.

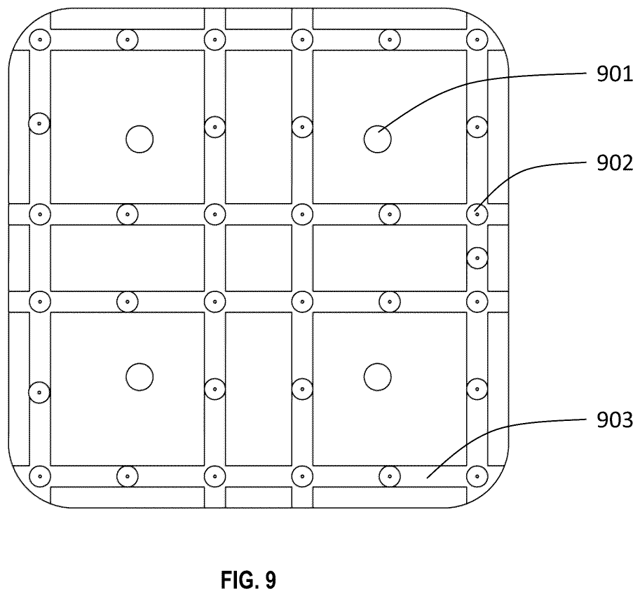

FIG. 9 shows a top-down perspective of the bottom of the same locator plate. Mounting holes 901 extend through the entire locator plate and may be arranged in any manner and, preferably, in a square arrangement. Smaller holes 902 and grooves 903 allow for air to escape during the thermoforming process that may get trapped between the thermoforming material. These holes 902 and grooves 903 can also be used with a vacuum system to provide suction to hold the thermoformed polymeric material securely to the locator plate. The diameter of the smaller holes 902 is not particularly limited. In a preferred embodiment, the smaller holes have a diameter of about 0.7 mm.

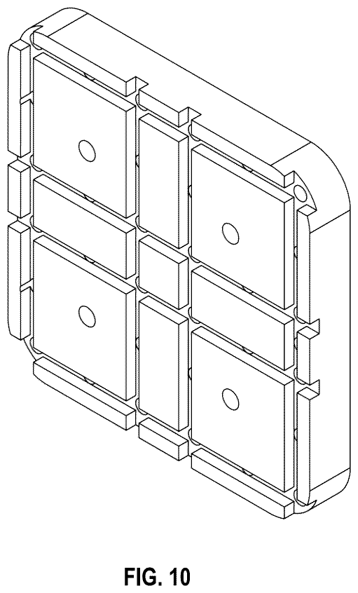

FIG. 10 shows a three-dimensional perspective of the bottom of the same locator plate. The mounting holes in FIG. 10 are arranged in a square arrangement but their position may be dependent on the thermoforming system. The grooves allow for air to escape during the thermoforming process that may get trapped between the thermoforming material and are not limited in dimensions.

The present technology is further directed to methods of thermoforming aligners.

In general, methods of the present technology feature using a locator plate and dental model for the formation of specific, customized patient aligners. Methods of the present technology can include using a locator plate. As a result of incorporating the locator plate, thermoforming advantages, including superior fit and accuracy with dental models are achieved.

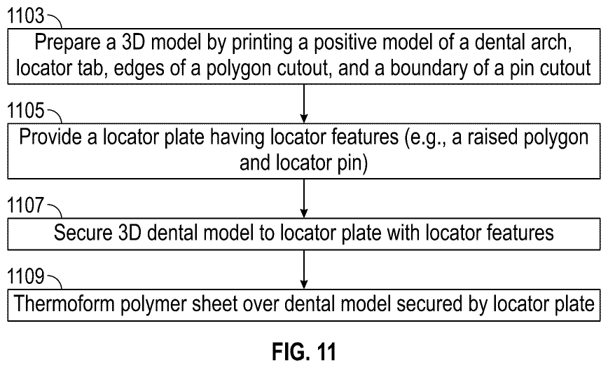

In one embodiment, the method of the present technology includes six steps such as demonstrated in the flowchart in FIG. 11.

The method begins by preparing a dental model for thermoforming. Dental models may be made by printing a 3D model (1103). This model may include a positive model of a dental arch and a 3D printed locator tab. While the locator tab is not limited in position, the locator tab matches a respective locator cutout. In an embodiment, the locator tab is preferably positioned within the interior of the dental arch. Printing may include printing edges of polygon cutout with the 3D printed tab as well as printing a boundary of a pin cutout within the 3D printed locator tab. These features are printed to match and correspond with a locator plate having respective cutouts of the features.

A locator plate having locator features as described herein is next provided for securing the dental model to the locator plate (1105). Preferred locator features of the locator plate include a raised polygon and a locator pin extending from a surface of the locator plate that assist in locating and securing to a 3D model. The locator plate may also include locator cones, which are concave conical indentations in the locator plate, that further assist in aligning the locator plate correctly.

The 3D dental model is then secured to the locator plate by positioning the locator features within the respective cutouts (1107). In a preferred example, the securing step involves positioning the raised polygon within the polygon cutout and positioning the locator pin within the pin cutout. The locator features of the locator plate will consistently ensure a secure fit with a dental model during the thermoforming process. The 3D model may also be moved into a proper position for thermoforming by repositioning the locator plate.

Once the locator plate is secured to the dental model and in the proper position, the thermoforming material may be thermoformed over the dental model (1109). The thermoforming material is preferably a polymer/thermoplastic sheet or film that is biocompatible and moldable over dental models once sufficient heat and/or pressure is applied.

The above method may have the following additional exemplary features.

In an example of the method, the raised polygon has a specific shape that assists in ensuring a secure fit. For example, the raised polygon of the locator plate may have an apex oriented toward an incisal portion of the dental arch, which indicates a proper orientation of the 3D dental model with respect to the raised polygon of the locator plate.

In an example of the method, the raised polygon of the locator plate and the polygon cutout within the 3D printed locator tab are pentagonal, which is generally optimal for securing dental arches.

Additional features of the locator plate in the method includes three concave locator cones formed within the surface of the locator plate from which the raised polygon and locator pin extend.

In some examples of the method, the concave locator cones are positioned in a triangular arrangement with respect to the raised polygon. The triangular arrangement of the locator cones ensures a proper orientation of the locator plate.

The locator cones may contain a thermoforming portion that assist with securing a dental model. Therefore, in some examples of the method, thermoforming the polymer sheet further includes thermoforming a portion of the polymer sheet within the concave locator cones. Moreover, the triangular arrangement of the concave locator cones, when transferred to the thermoformed polymer sheet, may indicate an orientation of the thermoformed polymer sheet. For example, the orientation of the triangular arrangement of the concave locator cones can have a particular position with respect to the incisal portion of the dental arch model. In such an embodiment, knowing the position of the locator cones can indicate the position of the dental arch model.

The present technology is further directed to a system for thermoforming an orthodontic aligner having a locator plate having a raised polygon and a locator pin extending from a surface of the locator plate. The thermoforming system includes a three-dimensional dental model and locator plate described above to produce aligners made from a thermoforming material.

In addition to a method, the present technology includes an embodiment of a thermoforming system that utilizes the locator plate.

Specifically, the system includes a 3D dental model including a positive model of a dental arch and a 3D printed locator tab positioned within an interior of the dental arch. The dental model is based on a digital scan of the patient's teeth, or a physical impression of the patient's teeth. Preferably, the dental model is based on a digital scan of the patient's teeth using an IOS device.

In an example of the system, the system includes a heat source for thermoforming a polymer sheet over the 3D dental model once secured to the locator plate. The heat source should sufficiently heat the thermoforming material such that the material molds over a dental model. The temperature at which heat is applied is dependent on the desired thermoforming material.

In some examples of the system, the system includes printing the 3D dental model that defines edges of a polygon cutout within the 3D printed locator tab and a boundary of a pin cutout within the 3D printed locator tab.

In additional examples of the system, the 3D dental model is capable of mating with the locator plate by positioning the raised polygon within the polygon cutout and positioning the locator pin within the pin cutout. The locator features, including, for example, the raised polygon, locator pin cutout, and locator cones optimize the thermoforming process by precisely orienting the locator plate relative to the dental model for a secure fit as the thermoforming material is heated and pressed on the dental model.

In some examples of the system, the 3D printed locator tab includes cutout lettering or raised lettering positioned along one or more edges of the polygon cutout. In a preferred example, the lettering is in the form of a hexadecimal code and may be cut through the entire locator plate. This lettering assists in identification and instructions to the thermoforming system using any suitable detector such as a camera having optical character recognition software.

For identification, the system further includes a camera for viewing and identifying the cutout lettering or raised lettering positioned along one or more edges of the polygon cutout.

As to the locator plate of the system, in some examples, the locator plate further defines three concave locator cones as a locator feature formed within the surface of the locator plate from which the raised polygon and locator pin extend, the concave locator cones being positioned in a triangular arrangement with respect to the raised polygon. The triangular arrangement of the concave locator cones, when transferred to the thermoformed polymer sheet, are useful for indicating an orientation of the thermoformed polymer sheet.

Specific embodiments and methods of securing thermoforming models have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A locator plate for receiving and securing individually unique dental models, the locator plate comprising:
a raised pentagon extending from a surface of the locator plate and having a rectangular bottom portion and an isosceles triangle top portion, the raised pentagon located in the center of the locator plate;
a locator pin spaced from the raised pentagon, the locator pin extending from the surface of the locator plate; and
optionally a first locator cone, a second locator cone, and a third locator cone spaced away from the raised pentagon and the locator pin in a triangular arrangement.

2. The plate of claim 1, wherein at least one of the raised pentagon and/or locator pin is chamfered.

3. The plate of claim 1, wherein the locator plate comprises raised lettering spaced away from the raised pentagon.

4. The plate of claim 1, further comprising a dental model affixed to the raised pentagon and the locator pin for forming a dental aligner.

5. The plate of claim 4, further comprising a polymer sheet drawn over the dental model.

6. A method of thermoforming a dental aligner, comprising:
printing a 3D dental model including a positive model of a dental arch, and a 3D printed locator tab positioned within an interior of the dental arch, wherein printing the 3D dental model includes:
printing edges of a polygon cutout within the 3D printed locator tab, and
printing a boundary of a pin cutout within the 3D printed locator tab,
providing a locator plate having a raised polygon and a locator pin extending from a surface of the locator plate;
securing the 3D dental model to the locator plate by positioning the raised polygon within the polygon cutout, and positioning the locator pin within the pin cutout; and
thermoforming a polymer sheet over the dental model secured to the locator plate.

7. The method of claim 6, further comprising:
moving the 3D dental model into a proper position for thermoforming by repositioning the locator plate.

8. The method of claim 6, wherein the raised polygon of the locator plate has an apex oriented toward an incisal portion of the dental arch indicating a proper orientation of the 3D dental model with respect to the raised polygon of the locator plate.

9. The method of claim 8, wherein the raised polygon of the locator plate and the polygon cutout within the 3D printed locator tab are pentagonal.

10. The method of claim 6, wherein printing the 3D dental model further includes:
3D printing edges of cutout lettering positioned along one or more edges of the polygon cutout.

11. The method of claim 6, wherein printing the 3D dental model further includes:
3D printing raised lettering positioned along one or more edges of the polygon cutout.

12. The method of claim 6, wherein the locator plate further defines three concave locator cones formed within the surface of the locator plate from which the raised polygon and locator pin extend.

13. The method of claim 12, wherein the concave locator cones are positioned in a triangular arrangement with respect to the raised polygon.

14. The method of claim 13, wherein thermoforming the polymer sheet further includes thermoforming a portion of the polymer sheet within the concave locator cones.

15. The method of claim 14, wherein the triangular arrangement of the concave locator cones, when transferred to the thermoformed polymer sheet, indicates an orientation of the thermoformed polymer sheet.

16. A system for thermoforming an orthodontic aligner, comprising:
a 3D dental model including a positive model of a dental arch, and a 3D printed locator tab positioned within an interior of the dental arch,
wherein printing the 3D dental model defines edges of a polygon cutout within the 3D printed locator tab and a boundary of a pin cutout within the 3D printed locator tab, and
wherein the 3D dental model mates with the locator plate by positioning the raised polygon within the polygon cutout, and positioning the locator pin within the pin cutout; and
a heat source for thermoforming a polymer sheet over the 3D dental model once secured to the locator plate.

17. The system of claim 16, wherein the 3D printed locator tab includes cutout lettering or raised lettering positioned along one or more edges of the polygon cutout.

18. The system of claim 17, further comprising:
a camera for viewing and identifying the cutout lettering or raised lettering positioned along one or more edges of the polygon cutout.

19. The system of claim 16, wherein the locator plate further defines three concave locator cones formed within the surface of the locator plate from which the raised polygon and locator pin extend, the concave locator cones being positioned in a triangular arrangement with respect to the raised polygon.

20. The method of claim 19, wherein the triangular arrangement of the concave locator cones, when transferred to the thermoformed polymer sheet, indicates an orientation of the thermoformed polymer sheet.
